(19) United States
(12) Patent Application Publication
(10) Pub. No.: US 2007/0209749 A1
(43) Pub. Date: Sep. 13, 2007

(54) Method and means for protecting a windshield from further damage before repair is possible

(76) Inventors: Dieter R. Berndt, Reno, NV (US); John Wyaux, Reno, NV (US); Thomas W. Berndt, Reno, NV (US)

Correspondence Address: DIETER R. BERNDT, 1292 WHITE CEDAR CT., RENO, NV, 89511, US

(21) Appl. No.: 11/709,112

(22) Filed: Feb. 21, 2007

Related U.S. Application Data
(60) Provisional application No. 60/782,016, filed on Mar. 13, 2006.

(51) Int. Cl. B29C 73/00

(52) U.S. Cl. 156/94

(57) ABSTRACT

A method and means for protecting a windshield from further damage from existing cracks or breaks due to stone or other hard object impacts on windshields. An optically clear impact resistant, high tensile strength barrier film is placed directly over the crack or break in the windshield. The barrier is preferably a clear polymeric film or clear multiples of film, but could be opaque, rubber, plastic or metal. The barrier is placed on the glass surface and in contact with the center of the crack or break. The size of the barrier is selected to eliminate the higher incidence of continued damage to the crack or break to the peripheral area. The barrier should be combined with a clear pressure backed adhesive with UV sunlight blocking ingredients to reduce degeneration. A kit can be assembled with the elements needed to place the barrier on a windshield. The barrier can also be applied in fluid form, which achieves a film. The barrier can extend not only over the front surface of the crack or break, but also over the edge surface and the back surface where it is needed.

### FIELD OF THE INVENTION

The invention relates to means and methods for preventing and protecting motor vehicle windshields from further damage caused by impacts from flying objects. In particular the invention relates to a clear protective barrier film placed directly over the damaged area and thus preventing the crack or break from spreading and further eliminating debris and moisture buildup within the crack or break to allow the most aesthetic and functional repair of said windshield by a windshield repair service technician.

### BACKGROUND

Damage to windshields caused by flying debris or other objects has long been a problem. Many patents have issued and a substantial business thrives respecting the repair of such damage. For a long time it was believed that long cracks, that is cracks over six inches in length could not be repaired. However, shorter cracks referred to as stone damage were repairable. Later through significant developments in the field it became possible to repair long cracks. Patents, which relate to the repair of cracks and/or breaks in windshields, are U.S. Pat. No. 5,116,441, U.S. Pat. No. 5,425,827, U.S. Pat. No. 5,429,692, U.S. patent application Ser. No. 08/436,155, U.S. patent application Ser. No. 08/436,591 and U.S. patent application Ser. No. 08/459,039.

Also, there is a thriving business in the replacement of cracked windshields, which either cannot be repaired or which are believed to be un-repairable. In fact replacement is vastly more common than repair and is largely attributed to poor repair techniques.

Despite these thriving businesses, damage to windshields present costs to the consumer and their insurance carriers, because of the cost of the repair or replacement. When insurance covers the damage then there is an insurance company loss, which is passed on to consumers through their premiums. Unfortunately, tons of un-recycled replacement windshields are created year after year contributing to our environmental waste problems.

Impacts, which cause damage virtually anywhere in a windshield but especially near the glass edge nearly always result in an edge crack that is a crack running through the impact point to the edge of the glass. These cracks can be quite long, that is over 5 inches in length and will eventually travel throughout a windshield. By contrast impacts in the middle area of the windshield quite often result only in the limited damage known as chips or stone damage that is a bulls-eye, a star break, a circular line break or a combination of either. The problem of windshield damage in both the peripheral area and the central visual area, demand attention soon after the crack or break is formed, too many end up getting extensively larger thus making windshield replacement the only remedy to what was originally a simple repair.

### SUMMARY OF THE INVENTION

The present invention provides a means and method for protecting a windshield from further damage from cracks and breaks due to stone or other hard object impacts by eliminating their ability to spread and pick up debris and moisture. According to the invention, an impact resistant protective barrier is placed directly upon the crack or break in the windshield. The barrier is preferably an optically clear polymeric film, but could be opaque rubber, plastic, glass or metal. The barrier film is placed on the glass surface and is held in contact by an adhesive, which is also optically clear and does not increase the visual distortion when viewing through it. The contact adhesive preferably is permanently placed on one side of the barrier film with a peel able liner for ease of application. Said adhesive shall be used which polymerizes over several hours which increases the surface rigidity and tensile strength of the film in contact with the windshield and the crack or break it may cover. The size of the protective barrier is selected to eliminate the higher incidence of damage in the peripheral area of the crack or break The crack or break size can range from as little as 0.25 inches in length or diameter to 12 inches in length or diameter depending on the force of the impact on the windshield and the resulting damage geometry.

In a preferred embodiment, an optically clear polymeric ultraviolet resistant protective barrier film, which can be polyester or polycarbonate, is from 2-12 mils thick with a preferred thickness of 5-6 mils. The range of 2-12 mils and the 56 mils thickness being especially preferred on bowed windshield portions as thicker films can be too stiff to arrest further damage.

In an alternate embodiment, the clear protective barrier film is polyester or polycarbonate consisting of laminated multi-layers, with the preferred multi-layers being 1 mil thick. The range of 4-8 mil layers being especially preferred to stop further damage on most windshield portions which may be due to drastic temperature changes to the glass or vibration.

In another alternative embodiment, the clear protective impact barrier is applied as a resinous fluid, which forms a film. The fluid may be applied by any desired method such as by brushing, dabbing, or spraying. Said resinous fluid may have optical curing agents or be solvent based to cure in the open air.

The clear protective barrier film embodiments of this invention are known to provide prevention of continued spreading of a high percentage of cracks and breaks in windshields on all motorized vehicles.

The clear protective barrier film could also be applied to tempered glass such as the back-glass and quarter-panels. These are made of tempered glass, but the back-glass may only be a single layer and quarter-panels are single layers. These are more susceptible to shattering when hit near the edge. Therefore, use of the present invention on the tempered glass outside surface can prevent enlargement of a breakage when applied to specific and sensitive areas.

### BRIEF DESCRIPTION OF DRAWINGS

FIG. 1 shows a front outside view of a windshield having the barrier film applied in an exemplary user application over a linear crack.

FIG. 2 shows a cross-sectional view of a windshield segment wherein a resinous fluid forms a clear protective barrier film after it is applied over a crack or break on the surface of said windshield.

FIG. 3 shows a partial cross-sectional view of a windshield segment with the clear protective barrier film after it is applied over a crack or break on the surface of a windshield.

### DETAILED DESCRIPTION

The invention is a method and means for protecting windshields from further fracture of an existing crack or break, most importantly cracks and breaks of the kind which, if they remain unattended will get larger and spread and thus require replacement of the windshield. This invention provides the method and means for an emergency interim windshield repair, literally on site shortly after the occurrence of a break.

Said repair is accomplished by placing a piece of self-adhesive plastic barrier film, which is cut into any desired geometric shape. The desired or optimal configuration or shape of the pre-cut plastic film is circular with a diameter of 0.5 to 5 inches or a rectangle with rounded corners whose sides are also 0.5 to 5 inches.

Plastic barrier film is supplied and used in many sizes including thickness, tensile strengths and rigidity in many plastic formulations. Selection of a film thickness and plastic formulation for use in this invention is such as to provide good surface adhesion and rigidity to prevent and/or restrict further damage from the impact which would allow a crack or break to become larger. In practice, the selected material will prevent any such further damage, even for a little chip break because as experienced in a real situation, a chip in the vulnerable peripheral area commonly leads to an edge crack. In order to minimize distortion of visibility through the film, the film must be optically clear and should be as thin as possible consistent with achieving the break arresting goal, and thus should be in the range of 2-12 mils in thickness depending upon the application.

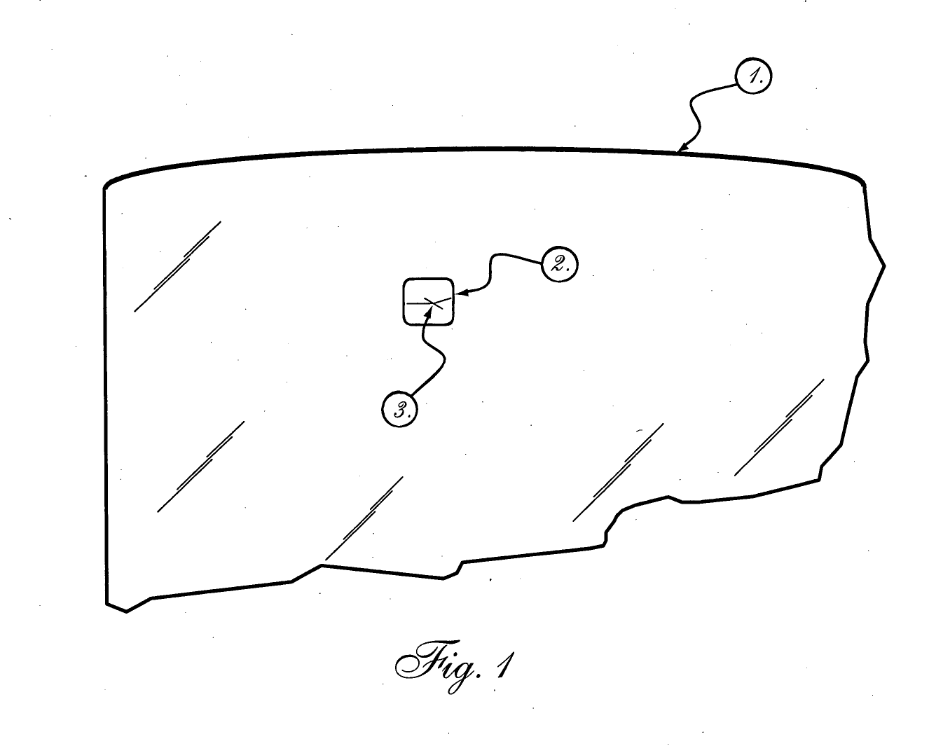

Referring to FIG. 1, in the present invention, an automobile windshield 1 having a break or crack 3 in the windshield is a subject of the invention. A clear plastic support barrier film 2 is placed and centered onto the break or crack. The barrier film 2 should have the selected dimension of being circular or square. It should be adhered semi-permanently to the windshield by an adhesive layer. Alternatively, the barrier film can be adhered in a manner, which allows periodic replacement, for example if the film becomes damaged or worn or loses its clarity.

Therefore, the film 2 has the tensile strength to hold the break or crack and keep it from getting larger due to changing temperature and/or shocks and vibration and will further protect the break from collecting moisture and debris of any type. Additionally, the optical clarity of the film 2 must not become a visual distraction to the driver.

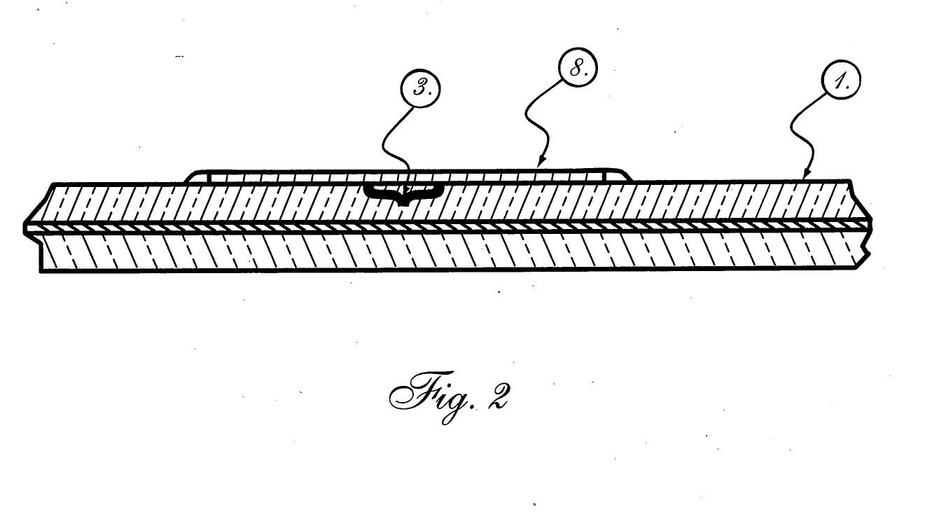

FIG. 2 FIG. 2 shows a cross-sectional view of a windshield segment wherein a resinous fluid forms a clear protective barrier film 8 after it is applied over a crack or break 3 on the surface of said windshield 1.

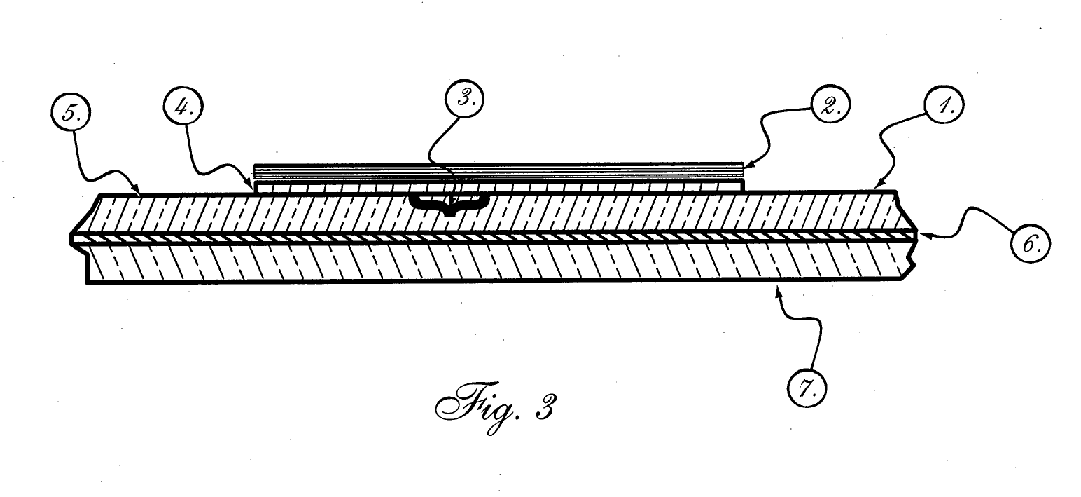

FIG. 3 shows a side view of the present invention, wherein the film 2 is attached to the windshield I by a clear adhesive 4 which spans the crack or break 3 in the attempt to keep it from getting larger and filling up with debris and moisture. The windshield is made up of two sandwiched glass portions, namely the outside portion I and the inside portion 7, held together by the transparent plastic laminate 6. Mostly all windshield breaks and cracks occur on the outside portion 5.

Over 55% of windshield cracks or breaks are typically caused by impacts in the peripheral area within 4 (four) inches (approximately 10 cm) of the exposed periphery of a windshield; that is, within a margin measured from the molding to about 4 inches into the glass area. It is interesting to note that most of these cracks are caused by rocks or other hard flying debris that start as a little chip break which ultimately grow to considerable lengths.

The plastic film is to be selected from a material that is optically clear and crack resistant and will not fog or discolor over time due to sunlight or severe weather conditions. The importance is optically clarity with no image distortion caused by the film material. It is imperative that the film does not add to the visual distraction to a driver of a vehicle to the existing windshield crack or break.

An exemplary film is 3M Scotchcal™. This is a 4-8 mil urethane plastic film sold by 3M. It has adhesive on one side, which will be activated by a solution of 25% isopropyl alcohol and 75% water, then this film can be applied to a surface for optimum protection. The film may be thicker, for example up to about 12 mils. The film should be as thick and rigid as necessary to absorb vibrations and surface shocks but not so thick as to interfere with any function of the windshield or the wipers.

Alternatively, in certain applications, the plastic film may be opaque, or the material may be glass or a multi-layered combination of plastic and glass.

An alternative form of the invention refers to a self-forming film made of a resinous fluid. Wherein said liquid resin is a made from a plastic polymer similar to the ones used to repair the windshield breaks. The plastic polymer resin can be formulated from an acrylic or silicone base compound which may include photo initiators which will tend to cure the applied resin very quickly when it is exposed to light. Said photo initiators may be sensitive to either the ultraviolet, infrared or visible part of the light spectrum.

Typical types of windshield damage is referred to as the so-called stone, rock or hard object damage, that is damage that does not leave a long crack, but frequently appears as a bulls-eye, star break or combination break. Sometimes stone damage results in later evolution of a long crack. However, in the vulnerable peripheral areas, an impact is most frequently seen as a small surface chip, absent any bulls-eye or starring but with a crack running through the impact point to the edge of the glass. A chip, which defines the point of impact, when near the edge is usually just pinhead size, but on some occasions it is a star or bulls-eye. In such cases, either instantly or very soon (minutes or at most a few hours) after impact a long crack appears running through the impact point to the edge of the glass (called an edge crack) said long crack may be 1 to 12 inches long. Exceptions are extremely rare. Cracks from the top and bottom often proceed vertically for a short distance, then turn horizontally. Virtually all cracks formed from an impact in the vulnerable area extend to the glass edge. Cracks that extend to the glass edge open wider than cracks, which don't extend to the glass edge and usually have a tendency to travel faster.

It is appreciated that application of a vibration and shock absorbent semi-rigid film or other protective barrier placed over an existing windshield break or crack may have to be different from that at the top and sides in many vehicles. This is because of the peculiar construction of some vehicles at and adjacent the bottom of the windshield. In certain cases the bottom of the windshield is under the level of the hood, and sometimes has as much as two inches of protection is afforded from the hood. The molding will be below the hood line. In such cases exposure of the windshield to damage begins at the level of the hood. That is, below the hood, it is not expected to see much damage. Thus, the vulnerable area is defined as beginning from the hood line, where the windshield extends below the hood line.

In another embodiment, the film is a clear semi-rigid polyester material. It can be a single-ply of film. A further preference is that the polyester film be a laminated multi-ply, more preferably 2-10 ply. Such films have a preferred thickness range of 4-12 mils, more preferably 7-8 mils, the most preferred thickness being 5 or 6 mils. The range of 4-12 mils thick is preferred when used with both flat and bowed windshield surfaces. The term bowed refers to curvature in the planar surface or body of the windshield, this term being used to distinguish over the term curved as related to the peripheral lines of a windshield. Sometimes bowing is a compound curvature, the windshield being bowed both horizontally and vertically. In the case of bowed surfaces, the film may be too stiff. Thus, it has been found that the thickness at 10-12 mils may be too stiff when applied to bowed surfaces while the 4-8-mil range is not too stiff. The most preferred thickness is 5 and 6 mils. These thickness designations refer to the nominal measurements provided by manufacturers of plastic film. The film thickness is also very important to reduce any obstruction to the windshield wiper blades.

Polyester films exemplary of the above description and having been used successfully on racing car windshields are made by MAbICO, Inc., Woburn, Mass. as its product designations LCL-600-XSR and LCL-800-XSR and a 5-7 mil film sold by that company.

Further, the preferred film size and shape should be circular with a 0.5 to 5 inch diameter and/or square or rectangular with rounded edges 0.5 to 5 inches square and 0.5 to 3 inches rectangular.

In another aspect of the invention, especially useful for marketing and promotional applications, is a small business card size kit prepared with peel-able 5-6 mil optically clear self-adhesive geometrically die cut polyester protective barrier film. The kit is designed to be universal for application and convenient to be applied on any windshield. It literally becomes as simple and analogous to apply the invention onto a windshield break as placing a band-aid on a human's scratch or wound. The kit will be conveniently sized to be a business card on one side, with instructions and several shapes of peel-able protective barrier film on the other side. Said shapes to be applicable to cover virtually any break or crack on a damaged windshield.

It is further stressed that materials, which will be successful as a protective barrier include those which can be applied with the utmost convenience by any driver and will have the ability to withstand a further impact and prevent vibrations from reaching the damaged part of the windshield. Said materials shall have the ability of having planar rigidity which will provide the tensile strength to resist the expanding forces within the break or crack. This is accomplished by keeping said break or crack from spreading or getting larger while said film is absorbing vibrations and thermal stresses. Said material will have different thickness and tensile strengths as provided by polymeric materials, such as polycarbonates, polyesters and poly-urethanes having good optical and visual clarity. Thin, 2-8 mil thick optically clear tempered glass or crystal may also be used instead of the plastic material as well as multi-layered combinations of each.

Although certain particular embodiments of the invention have been described and illustrated herein, it is recognized that modifications and variations may readily occur to those skilled in the art, and consequently it is intended that the claims be interpreted to cover such modifications and equivalents as they may apply.

What is claimed is:

1. A method and means of preventing a vehicle windshield against further damage from an existing crack or break comprising;
an impact resistant and high tensile strength protective optically clear and non-image distorting UV resistant barrier film selected from plastic or glass or any combination or multiple composite thereof,
where the protective barrier film is adhesive backed with a peel-able liner for ease of application of said film onto the glass of the windshield,
wherein the protective barrier film in the alternative to the above may be applied as an optically clear film forming resinous fluid, which is cured by air or sunlight.

2. The method of claim 1 wherein said impact resistant protective barrier film is at least 75% to 99.9% optically clear thereby not causing additional visual image distortion after it is applied over the crack or break on the windshield within the visual and peripheral viewing area.

3. The method of claim 1 wherein said impact resistant protective barrier film is comprised of a rigid to semi-rigid high tensile strength plastic or glass and can be applied to the windshield crack or break which by itself does not become an additional distraction to the driver and/or passenger after it is applied.

4. The method of claim 1 wherein said impact resistant protective barrier plastic film can be made with a self-adhesive film with peel-able liner for direct application over the windshield crack or break.

5. The method of claim 1 wherein said impact protective barrier film is in fluid form and can be applied to the windshield crack or break by brushing, spraying or dabbing, which by itself does not become an additional visual distraction to the driver and/or passenger after it is applied.

6. The method of claim 1 wherein said fluid protective barrier film dries or cures to a 75% to 99.9% optically clear without visual image distortion surface film while covering the crack or break on the windshield.

7. The method of claim 1 wherein said impact resistant protective barrier film can be sized to cover the complete surface area of a windshield inclusive of the crack or break.

8. A method of claim 1 wherein said impact resistant protective barrier is made of a high tensile strength material and maintains planar rigidity to further assist in arresting and/or preventing said crack or break in the windshield from spreading or getting larger due to vibration and thermal shock.

9. A method of claim 1 wherein said impact protective barrier film is protecting a crack or break in a windshield from filling up with debris and moisture.

10. A method of claim 1 wherein said impact protective barrier while guarding against debris and moisture and continue to arrest said crack or break from spreading across the whole windshield is comprised of a dry optically transparent self-adhesive film of which after application will provide a selected film thickness from 2 to 12 mil on said windshield in direct contact with the crack or break which is also impact and vibration absorbent.

11. A method of claim 1 wherein said impact protective barrier while guarding against debris and moisture and continue arresting said crack or break from spreading across the whole windshield is comprised of a dry optically transparent self-adhesive film further comprising of multiple of 1 mil thick pieces of film which after application will provide a selected film thickness from 2 to 12 mil on said windshield in direct contact with the crack or break which is also impact and vibration absorbent.

12. A method of claim 1 wherein said impact protective barrier while guarding against debris and moisture while continuing arresting said crack or break from spreading across the whole windshield is comprised of a fluid optically transparent film of which after application will provide a selected film thickness from 2 to 12 mil on said windshield in direct contact with the crack or break which is also impact and vibration absorbent
